(19) United States
(12) Patent Application Publication
(10) Pub. No.: US 2026/0162601 A1
(43) Pub. Date: Jun. 11, 2026

(54) PIXEL CIRCUIT, DISPLAY APPARATUS AND DRIVING METHOD

(71) Applicants: Chongqing BOE Display Technology Co., Ltd., Chongqing (CN); BOE Technology Group Co., Ltd., Beijing (CN)

(72) Inventors: Rui WANG, Beijing (CN); Yuanyou QIU, Beijing (CN); Runxin ZHANG, Beijing (CN); Shouqiang ZHANG, Beijing (CN); Ming HU, Beijing (CN)

(21) Appl. No.: 18/704,276

(22) PCT Filed: Jul. 26, 2023
(86) PCT No.: PCT/CN2023/109362

§ 371 Date: Apr. 24, 2024

(51) Int. Cl. G09G 3/3233; G09G 3/32

(52) U.S. Cl. CPC G09G 3/3233; G09G 3/32; G09G 2300/043; G09G 2300/0465; G09G 2300/0819; G09G 2300/0876; G09G 2310/08; G09G 2320/0233; G09G 2330/021

(57) ABSTRACT

Provided are a pixel circuit, display apparatus, and driving method. The pixel circuit includes: a light emitting device; a drive transistor, according to a data voltage signal, generating a drive current to drive the light emitting device to emit light; a first compensation circuit, in response to a signal of a first control signal terminal, providing a first reference signal of a first reference signal terminal to a first electrode of the drive transistor; a second compensation circuit, in response to a signal of a second control signal terminal and a signal of a third control signal terminal, providing a threshold voltage of the drive transistor and the first reference signal input into the first electrode of the drive transistor to a gate of the drive transistor; a data writing circuit; a coupling control circuit; and a light emitting control circuit.

### CROSS REFERENCE TO RELATED APPLICATIONS

The present disclosure is a US National Stage of International Application No. PCT/CN2023/109362, filed on Jul. 26, 2023, the entire contents of which are incorporated herein by reference.

### TECHNICAL FIELD

The present disclosure relates to the field of display technology, in particular to a pixel circuit, display apparatus and driving method.

### BACKGROUND

The organic light emitting diode (OLED) display is one of the hot spots in the current flat-panel display research field. Compared with the liquid crystal display (LCD), the OLED display has advantages of low energy consumption, low production cost, self-luminous, wide viewing angle and fast response speed. Here, a pixel circuit used to control light emitting devices is the core technology of OLED display, which is of great research significance. However, a pixel circuit of the existing OLED display includes a large number of transistors, resulting in a difficult process, an increase in production cost, and a large area occupied by the pixel circuit, which is not conducive to realizing a higher resolution of the OLED display.

### SUMMARY

Embodiments of the Present Disclosure Provide a Pixel Circuit, Including:
a light emitting device;
a drive transistor, coupled to the light emitting device, and configured, according to a data voltage signal, to generate a drive current to drive the light emitting device to emit light;
a first compensation circuit, coupled to the drive transistor, and configured, in response to a signal of a first control signal terminal, to provide a first reference signal of a first reference signal terminal to a first electrode of the drive transistor;
a second compensation circuit, coupled to the drive transistor, and configured, in response to a signal of a second control signal terminal and a signal of a third control signal terminal, to provide a threshold voltage of the drive transistor and the first reference signal input into the first electrode of the drive transistor to a gate of the drive transistor;
a data writing circuit, coupled to a first node, and configured, in response to a signal of a fourth control signal terminal, to provide the data voltage signal of a data signal terminal to the first node;
a coupling control circuit, coupled to the first node and the drive transistor, and configured to couple the data voltage signal of the first node to the gate of the drive transistor; and a light emitting control circuit, coupled to the light emitting device and the drive transistor, and configured, in response to a signal of a light emitting control signal terminal, to make conduction between the first electrode of the drive transistor and a first power supply terminal and make conduction between a second electrode of the drive transistor and the light emitting device to drive the light emitting device to emit light.

In some possible implementations, the first compensation circuit includes: a first transistor; wherein
a gate of the first transistor is coupled to the first control signal terminal, a first electrode of the first transistor is coupled to the first electrode of the drive transistor, and a second electrode of the first transistor is coupled to the first reference signal terminal.

In some possible implementations, the second compensation circuit includes: a second transistor and a third transistor; wherein
a gate of the second transistor is coupled to the second control signal terminal, a first electrode of the second transistor is coupled to a second node, and a second electrode of the second transistor is coupled to the second electrode of the drive transistor; and
a gate of the third transistor is coupled to the third control signal terminal, a first electrode of the third transistor is coupled to the gate of the drive transistor, and a second electrode of the third transistor is coupled to the second node.

In some possible implementations, the second compensation circuit further includes: a fourth transistor; wherein
a gate of the fourth transistor is coupled to a fifth control signal terminal, a first electrode of the fourth transistor is coupled to the gate of the drive transistor or the second node, and a second electrode of the fourth transistor is coupled to a first initialization signal terminal.

In some possible implementations, the fifth control signal terminal and the light emitting control signal terminal are the same one signal terminal.

In some possible implementations, the data writing circuit includes: a fifth transistor; wherein
a gate of the fifth transistor is coupled to the fourth control signal terminal, a first electrode of the fifth transistor is coupled to the data signal terminal, and a second electrode of the fifth transistor is coupled to the first node.

In some possible implementations, the coupling control circuit includes: a first capacitor; wherein
a first electrode of the first capacitor is coupled to the first node, and a second electrode of the first capacitor is coupled to the gate of the drive transistor.

In some possible implementations, the light emitting control circuit includes: a sixth transistor and a seventh transistor; wherein
a gate of the sixth transistor is coupled to the light emitting control signal terminal, a first electrode of the sixth transistor is coupled to the first power supply terminal, and a second electrode of the sixth transistor is coupled to the first electrode of the drive transistor; and
a gate of the seventh transistor is coupled to the light emitting control signal terminal, a first electrode of the seventh transistor is coupled to the second electrode of the drive transistor, and a second electrode of the seventh transistor is coupled to the light emitting device.

In some possible implementations, the pixel circuit further includes: a first reset circuit, coupled to the light emitting device, and configured, in response to a signal of a sixth control signal terminal, to provide a signal of a second initialization signal terminal to the light emitting device.

In some possible implementations, the first reset circuit includes: an eighth transistor; wherein
a gate of the eighth transistor is coupled to the sixth control signal terminal, a first electrode of the eighth transistor is coupled to the light emitting device, and a second electrode of the eighth transistor is coupled to the second initialization signal terminal.

In some possible implementations, the pixel circuit further includes: a voltage regulator circuit, coupled to the first node, and configured to stabilize a voltage at the first node.

In some possible implementations, the voltage regulator circuit includes: a second capacitor; wherein
a first electrode of the second capacitor is coupled to the first power supply terminal and a second electrode of the second capacitor is coupled to the first node.

In some possible implementations, the pixel circuit further includes: a second reset circuit, coupled to the second electrode of the drive transistor, and configured, in response to a signal of a seventh control signal terminal, to provide a signal of a third initialization signal terminal to the second electrode of the drive transistor.

In some possible implementations, the second reset circuit includes: a ninth transistor; wherein
a gate of the ninth transistor is coupled to the seventh control signal terminal, a first electrode of the ninth transistor is coupled to the second electrode of the drive transistor, and a second electrode of the ninth transistor is coupled to the third initialization signal terminal.

In some possible implementations, the pixel circuit further includes: a third reset circuit, coupled to the first node, and configured, in response to a signal of an eighth control signal terminal, to provide a signal of a second reference signal terminal to the first node.

In some possible implementations, the third reset circuit includes: a tenth transistor; wherein
a gate of the tenth transistor is coupled to the eighth control signal terminal, a first electrode of the tenth transistor is coupled to the first node, and a second electrode of the tenth transistor is coupled to the second reference signal terminal.

In some possible implementations, the third reset circuit includes: an eleventh transistor and a twelfth transistor; wherein
a gate of the eleventh transistor is coupled to the eighth control signal terminal, a first electrode of the eleventh transistor is coupled to the first node, and a second electrode of the eleventh transistor is coupled to a third node; and
a gate of the twelfth transistor is coupled to the eighth control signal terminal, a first electrode of the twelfth transistor is coupled to the third node, and a second electrode of the eleventh transistor is coupled to the second reference signal terminal.

In some possible implementations, the third reset circuit further includes: a thirteenth transistor; wherein
a gate of the thirteenth transistor is coupled to a ninth control signal terminal, a first electrode of the thirteenth transistor is coupled to the third node, and a second electrode of the thirteenth transistor is coupled to a third reference signal terminal.

A display apparatus provided by embodiments of the present disclosure includes the above pixel circuit.

A driving method of the pixel circuit provided by embodiments of the present disclosure, includes:
in a reset stage: providing, by the first compensation circuit, the first reference signal of the first reference signal terminal to the first electrode of the drive transistor in response to the signal of the first control signal terminal;
in a threshold compensation stage: providing, by the first compensation circuit, the first reference signal of the first reference signal terminal to the first electrode of the drive transistor in response to the signal of the first control signal terminal; and providing, by the second compensation circuit, the threshold voltage of the drive transistor and the first reference signal input into the first electrode of the drive transistor to the gate of the drive transistor in response to the signal of the second control signal terminal and the signal of the third control signal terminal;
in a data writing stage: providing, by the data writing circuit, the data voltage signal of the data signal terminal to the first node in response to the signal of the fourth control signal terminal; and coupling, by the coupling control circuit, the data voltage signal of the first node to the gate of the drive transistor; and
in a light emitting stage: making, by the light emitting control circuit, conduction between the first electrode of the drive transistor and the first power supply terminal, and conduction between the second electrode of the drive transistor and the light emitting device to drive the light emitting device to emit light in response to the signal of the light emitting control signal terminal.

### BRIEF DESCRIPTION OF FIGURES

FIG. 1 shows a schematic diagram of some structures of a pixel circuit provided by embodiments of the present disclosure.

FIG. 2 shows a schematic diagram of some other structures of a pixel circuit provided by embodiments of the present disclosure.

FIG. 3 shows a flowchart of a driving method of a pixel circuit provided by embodiments of the present disclosure.

FIG. 4 shows a timing chart of some signals provided by embodiments of the present disclosure.

FIG. 5 shows a schematic diagram of yet some other structures of a pixel circuit provided by embodiments of the present disclosure.

FIG. 6 shows a timing chart of some other signals provided by embodiments of the present disclosure.

FIG. 7 shows a schematic diagram of yet some other structures of a pixel circuit provided by embodiments of the present disclosure.

FIG. 8 shows a timing chart of yet some other signals provided by embodiments of the present disclosure.

FIG. 9 shows a schematic diagram of yet some other structures of a pixel circuit provided by embodiments of the present disclosure.

FIG. 10 shows a timing chart of yet some other signals provided by embodiments of the present disclosure.

FIG. 11 shows a schematic diagram of yet some other structures of a pixel circuit provided by embodiments of the present disclosure.

FIG. 12 shows a schematic diagram of yet some other structures of a pixel circuit provided by embodiments of the present disclosure.

### DETAILED DESCRIPTION

In order to make the objects, technical solutions and advantages of the embodiments of the present disclosure clearer, the technical solutions of the embodiments of the present disclosure will be described clearly and completely in the following in conjunction with the accompanying drawings of the embodiments of the present disclosure. Obviously, the described embodiments are a part of the embodiments of the present disclosure and not all of the embodiments. Additionally, the embodiments and the features in the embodiments of the present disclosure can be combined with each other without conflict. Based on the described embodiments of the present disclosure, all other embodiments obtained by a person of ordinary skill in the art without the need for creative labor are within the protection scope of the present disclosure.

Unless otherwise defined, technical or scientific terms used in the present disclosure shall have the ordinary meaning understood by a person of ordinary skill in the field to which the present disclosure belongs. The terms “first”, “second”, and the like as used in the present disclosure do not indicate any order, number, or significance, but are only used to distinguish different components. The word “including” or “comprising” and the like are intended to mean that the component or object preceded by the word encompasses the components or objects listed after the word and their equivalents, and does not exclude other components or objects. The Word such as “connected” or “coupled” is not limited to physical or mechanical connections, but may include electrical connections, whether direct or indirect electrical connections.

It should be noted that the sizes and shapes of the figures in the accompanying drawings do not reflect true proportions, but are intended to be illustrative of the present disclosure. Additionally, throughout the same or similar reference numerals denote the same or similar elements or elements having the same or similar functions.

A display apparatus provided by embodiments of the present disclosure may include a display panel. The display panel may include a base substrate. Wherein the base substrate may include a display region and a non-display region (i.e., a region in the base substrate other than a region surrounded by the display region). Wherein the display region may include a plurality of pixel units arranged in an array. Exemplarily, each pixel unit includes sub-pixels of the same color or a plurality of sub-pixels of different colors. For example, the pixel units may include red sub-pixels, green sub-pixels, and blue sub-pixels, so that color mixing can be performed by red, green, and blue for a colorful display. Alternatively, the pixel units may include red sub-pixels, green sub-pixels, blue sub-pixels, and white sub-pixels, so that color mixing can be performed by red, green, blue, and white for a colorful display. Of course, in actual application, light emitting colors of the sub-pixels in the pixel units may be designed and determined according to the actual application environment, which is not limited herein.

In embodiments of the present disclosure, each sub-pixel may include a pixel circuit and a light emitting device coupled to the pixel circuit, and the pixel circuit may include a drive transistor to control the light emitting device to emit light, so as to enable the display panel to realize the picture display. A threshold voltage Vth of the drive transistor may drift due to process, aging, or the like, which may have an impact on the generated drive current, resulting in a poor display effect. Therefore, the threshold voltage Vth of the drive transistor will be compensated, but in the related art, the threshold voltage Vth is compensated while data charging, which leads to the phenomenon that the compensating and charging speed is too slow, and thus cannot be applicable to a circuit with high frequency.

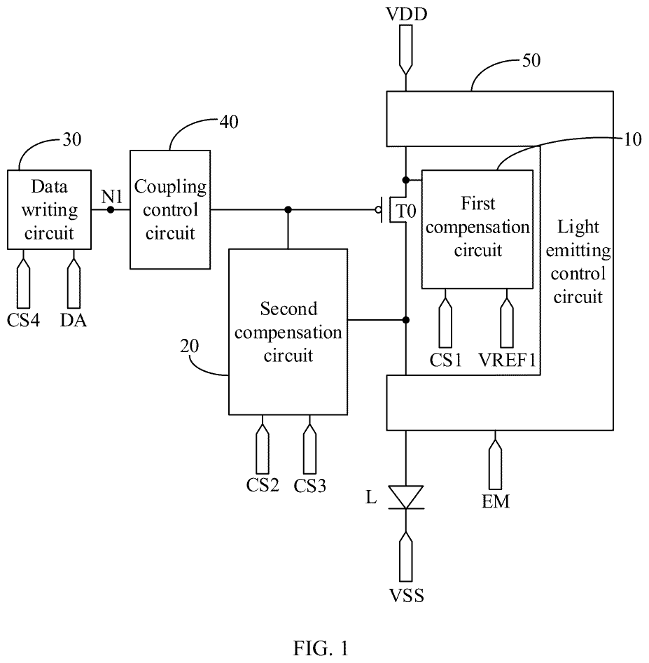

In view of this, embodiments of the present disclosure provide a pixel circuit, as shown in FIG. 1, including:
a light emitting device L;
a drive transistor T0, coupled to the light emitting device L, and configured, according to a data voltage signal, to generate a drive current to drive the light emitting device L to emit light;
a first compensation circuit 10, coupled to the drive transistor T0, and configured, in response to a signal of a first control signal terminal CS1, to provide a first reference signal of a first reference signal terminal VREF1 to a first electrode of the drive transistor T0;
a second compensation circuit 20, coupled to the drive transistor T0, and configured, in response to a signal of a second control signal terminal CS2 and a signal of a third control signal terminal CS3, to provide a threshold voltage Vth of the drive transistor T0 and the first reference signal input into the first electrode of the drive transistor T0 to a gate of the drive transistor T0;
a data writing circuit 30, coupled to a first node N1, and configured, in response to a signal of a fourth control signal terminal CS4, to provide the data voltage signal of a data signal terminal DA to the first node N1;
a coupling control circuit 40, coupled to the first node N1 and the drive transistor T0, and configured to couple the data voltage signal of the first node N1 to the gate of the drive transistor T0; and
a light emitting control circuit 50, coupled to the light emitting device L and the drive transistor T0, and configured, in response to a signal of a light emitting control signal terminal EM, to make conduction between the first electrode of the drive transistor T0 and the first power supply terminal VDD and make conduction between the second electrode of the drive transistor T0 and the light emitting device L to drive the light emitting device L to emit light.

The pixel circuit provided by the embodiments of the present disclosure realizes that the compensation for the threshold voltage Vth and the data charging are carried out in time-sharing through the mutual cooperation of the light emitting device, the drive transistor, the first compensation circuit, the second compensation circuit, the data writing circuit, the coupling control circuit, and the light emitting control circuit, so that the compensation for the threshold voltage Vth is no longer limited and there is more time to carry out the compensation, which improves the compensation effect, and improves the display effect under the low gray scale.

Moreover, by adopting the first compensation circuit to provide the first reference signal of the first reference signal terminal to the first electrode of the drive transistor, and the second compensation circuit to provide the threshold voltage of the drive transistor and the first reference signal input into the first electrode of the drive transistor to the gate of the drive transistor to compensate the threshold voltage Vth of the drive transistor, which can further reduce the light emitting control signal terminals required for the light emitting control circuit. That is, a simple structure and fewer signal lines are used to drive the light emitting device to emit light, so that the preparation process can be simplified, the production cost can be reduced, and the occupied area can be reduced, the pixel density can be increased, which is conducive to realizing a higher resolution and improving the display effect.

Exemplarily, as shown in FIG. 1, the drive transistor T0 may be provided as a P-type transistor; wherein the first electrode of the drive transistor T0 may be the source thereof, the second electrode of the drive transistor T0 may be the drain thereof, and when the drive transistor T0 is in a saturated state, a current flows from the source of the drive transistor T0 to the drain thereof. Of course, the drive transistor T0 may also be provided as an N-type transistor, which is not limited herein.

Exemplarily, as shown in FIG. 1, the second electrode of the light emitting device L is coupled to the second power supply terminal VSS. Exemplarily, the light emitting device L may be an electroluminescent diode. For example, the light emitting device L may include at least one of: an organic light emitting diode (OLED), a quantum dot light emitting diode (QLED), a micro light emitting diode (Micro LED), or a mini light emitting diode Mini LED), etc. Exemplarily, the light emitting device L may include an anode, a light emitting layer, and a cathode that are stacked. Further, the light emitting layer may further include film layers such as a hole injection layer, a hole transport layer, an electron transport layer, and an electron injection layer, etc. Of course, in practice, the specific structure of the light emitting device L can be determined according to the needs of the actual application, which is not limited herein.

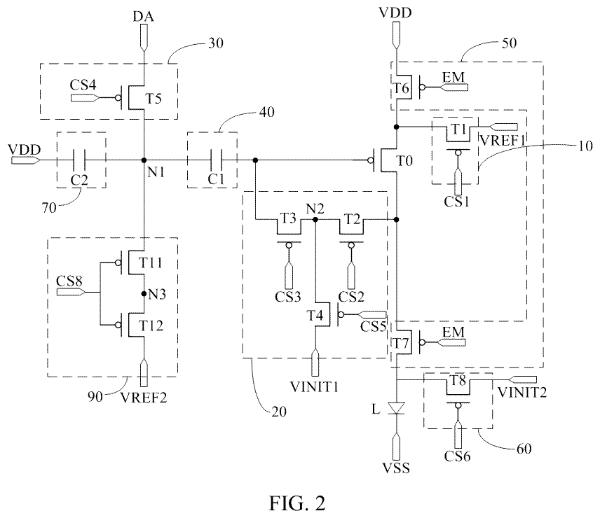

In the embodiments of the present disclosure, as shown in FIG. 2, the first compensation circuit 10 includes: a first transistor T1; wherein a gate of the first transistor T1 is coupled to a first control signal terminal CS1, the first electrode of the first transistor T1 is coupled to a first electrode of the drive transistor T0, and a second electrode of the first transistor T1 is coupled to the first reference signal terminal VREF1.

Exemplarily, the first transistor T1 may be turned on under the control of an effective level of the first control signal transmitted at the first control signal terminal CS1 and may be turned off under the control of an ineffective level of the first control signal. For example, the first transistor T1 may be provided as an N-type transistor, so that the effective level of the first control signal is a high level and the ineffective level of the first control signal is a low level. Alternatively, the first transistor T1 may be provided as a P-type transistor, so that the effective level of the first control signal is a low level and the ineffective level of the first control signal is a high level.

In the embodiments of the present disclosure, as shown in FIG. 2, the second compensation circuit 20 includes: a second transistor T2 and a third transistor T3; wherein a gate of the second transistor T2 is coupled to the second control signal terminal CS2, a first electrode of the second transistor T2 is coupled to the second node N2, and a second electrode of the second transistor T2 is coupled to the second electrode of the drive transistor T0; and a gate of the third transistor T3 is coupled to the third control signal terminal CS3, a first electrode of the third transistor T3 is coupled to the gate of the drive transistor T0, and a second electrode of the third transistor T3 is coupled to the second node N2.

Exemplarily, the second transistor T2 may be turned on under the control of an effective level of the second control signal transmitted at the second control signal terminal CS2, and may be turned off under the control of an ineffective level of the second control signal. For example, the second transistor T2 may be provided as an N-type transistor, so that the effective level of the second control signal is a high level and the ineffective level of the second control signal is a low level. Alternatively, the second transistor T2 may be provided as a P-type transistor, so that the effective level of the second control signal is a low level and the ineffective level of the second control signal is a high level.

Exemplarily, the third transistor T3 may be turned on under the control of the effective level of the third control signal transmitted at the third control signal terminal CS3, and may be turned off under the control of the ineffective level of the third control signal. For example, the third transistor T3 may be provided as an N-type transistor, so that the effective level of the third control signal is a high level and the ineffective level of the third control signal is a low level. Alternatively, the third transistor T3 may be provided as a P-type transistor, so that the effective level of the third control signal is a low level and the ineffective level of the third control signal is a high level.

In the embodiments of the present disclosure, as shown in FIG. 2, the second compensation circuit 20 further includes: a fourth transistor T4; wherein a gate of the fourth transistor T4 is coupled to a fifth control signal terminal CS5, a first electrode of the fourth transistor T4 is coupled to the second node N2, and a second electrode of the fourth transistor T4 is coupled to a first initialization signal terminal VINIT1.

Exemplarily, the fourth transistor T4 may be turned on under the control of an effective level of the fifth control signal transmitted at the fifth control signal terminal CS5, and may be turned off under the control of an ineffective level of the fifth control signal. For example, the fourth transistor T4 may be provided as an N-type transistor, so that the effective level of the fifth control signal is a high level and the ineffective level of the fifth control signal is a low level. Alternatively, the fourth transistor T4 may be provided as a P-type transistor, so that the effective level of the fifth control signal is a low level and the ineffective level of the fifth control signal is a high level.

In the embodiments of the present disclosure, as shown in FIG. 2, the data writing circuit 30 includes: a fifth transistor T5; wherein a gate of the fifth transistor T5 is coupled to the fourth control signal terminal CS4, a first electrode of the fifth transistor T5 is coupled to the data signal terminal DA, and a second electrode of the fifth transistor T5 is coupled to the first node N1.

Exemplarily, the fifth transistor T5 may be turned on under the control of an effective level of the fourth control signal transmitted at the fourth control signal terminal CS4, and may be turned off under the control of an ineffective level of the fourth control signal. For example, the fifth transistor T5 may be provided as an N-type transistor, so that the effective level of the fourth control signal is a high level and the ineffective level of the fourth control signal is a low level. Alternatively, the fifth transistor T5 may be provided as a P-type transistor, so that the effective level of the fourth control signal is a low level and the ineffective level of the fourth control signal is a high level.

In the embodiments of the present disclosure, as shown in FIG. 2, the coupling control circuit 40 includes: a first capacitor C1; wherein a first electrode of the first capacitor C1 is coupled to the first node N1, and a second electrode of the first capacitor C1 is coupled to the gate of the drive transistor T0.

In the embodiments of the present disclosure, as shown in FIG. 2, the light emitting control circuit 50 includes: a sixth transistor T6 and a seventh transistor T7; wherein a gate of the sixth transistor T6 is coupled to the light emitting control signal terminal EM, a first electrode of the sixth transistor T6 is coupled to the first power supply terminal VDD, and a second electrode of the sixth transistor T6 is coupled to the first electrode of the drive transistor T0; and a gate of the seventh transistor T7 is coupled to the light emitting control signal terminal EM, a first electrode of the seventh transistor T7 is coupled to the second electrode of the drive transistor T0, and a second electrode of the seventh transistor T7 is coupled to the light emitting device L.

Exemplarily, the sixth transistor T6 may be turned on under the control of an effective level of the light emitting control signal transmitted at the light emitting control signal terminal EM and may be turned off under the control of an ineffective level of the light emitting control signal. For example, the sixth transistor T6 may be provided as an N-type transistor, so that the effective level of the light emitting control signal is a high level and the ineffective level of the light emitting control signal is a low level. Alternatively, the sixth transistor T6 may be provided as a P-type transistor, so that the effective level of the light emitting control signal is a low level and the ineffective level of the light emitting control signal is a high level.

Exemplarily, the seventh transistor T7 may be turned on under the control of the effective level of the light emitting control signal transmitted at the light emitting control signal terminal EM, and may be turned off under the control of the ineffective level of the light emitting control signal. For example, the seventh transistor T7 may be provided as an N-type transistor, so that the effective level of the light emitting control signal is a high level and the ineffective level of the light emitting control signal is a low level. Alternatively, the seventh transistor T7 may be provided as a P-type transistor, so that the effective level of the light emitting control signal is a low level and the ineffective level of the light emitting control signal is a high level.

In the embodiments of the present disclosure, as shown in FIG. 2, the display panel further includes: a first reset circuit 60, coupled to the light emitting device L, and configured, in response to a signal of a sixth control signal terminal CS6, to provide a signal of a second initialization signal terminal VINIT2 to the light emitting device L.

In the embodiments of the present disclosure, as shown in FIG. 2, the first reset circuit 60 includes: an eighth transistor T8; wherein a gate of the eighth transistor T8 is coupled to the sixth control signal terminal CS6, a first electrode of the eighth transistor T8 is coupled to the light emitting device L, and a second electrode of the eighth transistor T8 is coupled to the second initialization signal terminal VINIT2.

Exemplarily, the eighth transistor T8 may be turned on under the control of an effective level of the sixth control signal transmitted at the sixth control signal terminal CS6, and may be turned off under the control of an ineffective level of the sixth control signal. For example, the eighth transistor T8 may be provided as an N-type transistor, so that the effective level of the sixth control signal is a high level and the ineffective level of the sixth control signal is a low level. Alternatively, the eighth transistor T8 may be provided as a P-type transistor, so that the effective level of the sixth control signal is a low level and the ineffective level of the sixth control signal is a high level.

In the embodiments of the present disclosure, as shown in FIG. 2, the pixel circuit further includes: a voltage regulator circuit 70, coupled to the first node N1, and configured to stabilize a voltage at the first node N1.

In the embodiments of the present disclosure, as shown in FIG. 2, the voltage regulator circuit 70 includes: a second capacitor C2; wherein a first electrode of the second capacitor C2 is coupled to the first power supply terminal VDD, and a second electrode of the second capacitor C2 is coupled to the first node N1.

In the embodiments of the present disclosure, as shown in FIG. 2, the pixel circuit further includes: a third reset circuit 90, coupled to the first node N1, and configured, in response to a signal of an eighth control signal terminal CS8, to provide a signal of a second reference signal terminal VREF2 to the first node N1.

In the embodiments of the present disclosure, as shown in FIG. 2, the third reset circuit 90 includes: an eleventh transistor T11 and a twelfth transistor T12; wherein a gate of the eleventh transistor T11 is coupled to the eighth control signal terminal CS8, a first electrode of the eleventh transistor T11 is coupled to the first node N1, and a second electrode of the eleventh transistor T11 is coupled to a third node N3; and a gate of the twelfth transistor T12 is coupled to the eighth control signal terminal CS8, a first electrode of the twelfth transistor T12 is coupled to the third node N3, and a second electrode of the twelfth transistor T12 is coupled to the second reference signal terminal VREF2.

Exemplarily, the eleventh transistor T11 may be turned on under the control of an effective level of the eighth control signal transmitted at the eighth control signal terminal CS8 and may be turned off under the control of an ineffective level of the eighth control signal. For example, the eleventh transistor T11 may be provided as an N-type transistor, so that the effective level of the eighth control signal is a high level and the ineffective level of the eighth control signal is a low level. Alternatively, the eleventh transistor T11 may be provided as a P-type transistor, so that the effective level of the eighth control signal is a low level and the ineffective level of the eighth control signal is a high level.

Exemplarily, the twelfth transistor T12 may be turned on under the control of the effective level of the eighth control signal transmitted at the eighth control signal terminal CS8, and may be turned off under the control of the ineffective level of the eighth control signal. For example, the twelfth transistor T12 may be provided as an N-type transistor, so that the effective level of the eighth control signal is a high level and the ineffective level of the eighth control signal is a low level. Alternatively, the twelfth transistor T12 may be provided as a P-type transistor, so that the effective level of the eighth control signal is a low level and the ineffective level of the eighth control signal is a high level.

Exemplarily, the first electrode of the transistor described above may be the source thereof and the second electrode of the transistor described above may be the drain thereof. Alternatively, the first electrode may be the drain thereof and the second electrode may be the source thereof. No limitation is made herein.

Generally, the transistor(s) using the low temperature poly-silicon (LTPS) material as the active layer have a high mobility and can be made thinner and smaller and be provided with lower power consumption, etc. In specific implementation, the material of the active layer of at least one of the transistors described above can be provided as the low temperature poly-silicon material. In this way, the transistor(s) described above can be provided as the LTPS-type transistor, so that the pixel circuit realizes a high mobility and can be made thinner and smaller with lower power consumption.

Generally, the leakage current of the transistor using the metal oxide semiconductor material as the active layer is small. Therefore, in order to reduce the leakage current, in some embodiments of the present disclosure, the material of the active layer of the at least one of the transistors described above may include a metal oxide semiconductor material, e.g., IGZO (indium gallium zinc oxide), and of course, may be other metal oxide semiconductor materials, which is not limited herein. In this way, the transistors described above may be provided as oxide thin film transistor, so that the leakage current of the pixel circuit is reduced.

Exemplarily, all of the transistors can be provided as LTPS type transistors. Alternatively, all of the transistors may be provided as oxide type transistors. Alternatively, some of the transistors may be provided as oxide-type transistors and the remaining transistors may be provided as LTPS-type transistors. By combining two processes for preparing the LTPS-type transistors and the oxide-type transistors, the low-temperature polycrystalline silicon oxide (LTPO) pixel circuit can be prepared, which causes the leakage current of the gate of the drive transistor T0 to be small and the power consumption to be low. Thereby, the pixel circuit is applied to a display panel, and uniformity of display can be ensured when reducing refresh frequency for display by the display panel.

Exemplarily, the first power supply terminal VDD may be configured to be loaded with a constant first power supply voltage Vdd, and the first power supply voltage Vdd is generally of a positive value, e.g., the first power supply voltage Vdd includes 4.6v and the like. As well, the second power supply terminal VSS may be loaded with a constant second power supply voltage Vss, and the second power supply voltage Vss may generally be a ground voltage or is of a negative value, e.g., the second power supply voltage Vss includes −5 v, etc. In practice, the specific values of the first power supply voltage Vdd and the second power supply voltage Vss may be designed and determined according to the actual application environment, which are not limited herein.

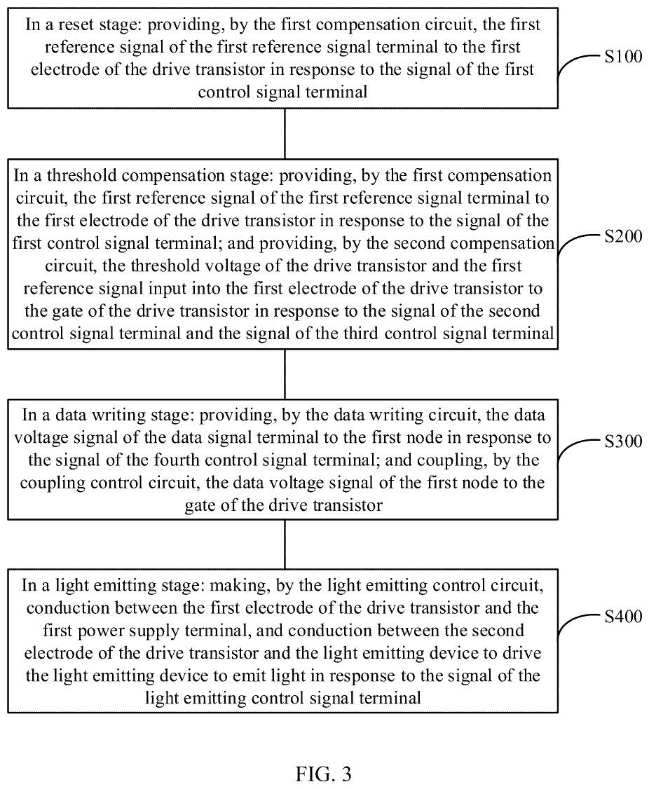

In the embodiments of the present disclosure, as shown in FIG. 3, a driving method of a pixel circuit in embodiments of the present disclosure may include the following steps.

S100, in a reset stage: the first compensation circuit, in response to the signal of the first control signal terminal, provides the first reference signal of the first reference signal terminal to the first electrode of the drive transistor.

S200, in a threshold compensation stage: the first compensation circuit, in response to the signal of the first control signal terminal, provides the first reference signal of the first reference signal terminal to the first electrode of the drive transistor; the second compensation circuit, in response to the signal of the second control signal terminal and the signal of the third control signal terminal, provides the threshold voltage of the drive transistor and the first reference signal input into the first electrode of the drive transistor to the gate of the drive transistor.

S300, in a data writing stage: the data writing circuit, in response to the signal of the fourth control signal terminal, provides the data voltage signal of the data signal terminal to the first node; and the coupling control circuit couples the data voltage signal of the first node to the gate of the drive transistor.

S400, in a light emitting stage: the light emitting control circuit, in response to the signal of the light emitting control signal terminal, makes conduction between the first electrode of the drive transistor and the first power supply terminal and conduction between the second electrode of the drive transistor to the light emitting device to drive the light emitting device to emit light.

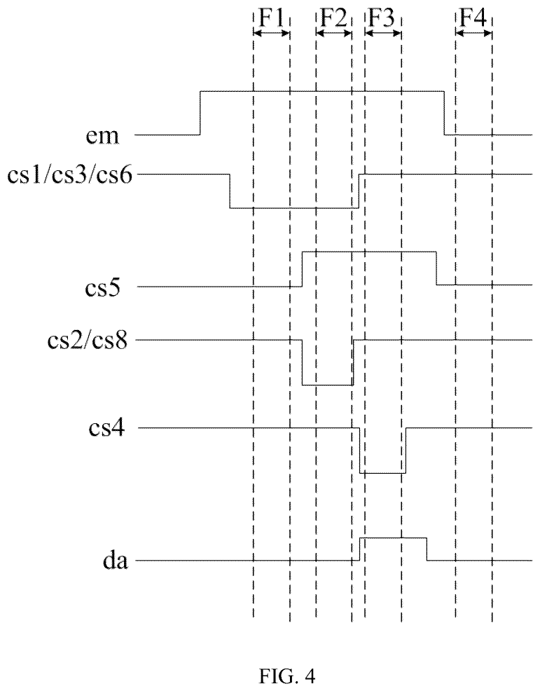

The following is a description of the operating process of the pixel circuit provided by the embodiment of the present disclosure, using the pixel circuit shown in FIG. 2 as an example, in conjunction with the timing chart of signals shown in FIG. 4.

Here, as shown in FIG. 4, em represents a light emitting signal of the light emitting control signal terminal EM, cs1 represents a first control signal of the first control signal terminal CS1, cs2 represents a second control signal of the second control signal terminal CS2, cs3 represents a third control signal of the third control signal terminal CS3, cs4 represents a fourth control signal of the fourth control signal terminal CS4, cs5 represents a fifth control signal of the fifth control signal terminal CS5, cs6 represents a sixth control signal of the sixth control signal terminal CS6, cs8 represents an eighth control signal of the eighth control signal terminal CS8, and da represents a data voltage signal of the data signal terminal DA.

In the reset stage F1: the first transistor T1 is turned on under the control of a low level of the first control signal cs1, the second transistor T2 is turned off under the control of a high level of the second control signal cs2, the third transistor T3 is turned on under the control of a low level of the third control signal cs3, the fourth transistor T4 is turned on under the control of a low level of the fifth control signal cs5, the fifth transistor T5 is turned off under the control of a high level of the fourth control signal cs4, the sixth transistor T6 is turned off under the control of a high level of the light emitting signal em, the seventh transistor T7 is turned off under the control of the high level of the light emitting signal em, the eighth transistor T8 is turned on under the control of a low level of the sixth control signal cs6, the eleventh transistor T11 is turned off under the control of a high level of the eighth control signal cs8, and the twelfth transistor T12 is turned off under the control of the high level of the eighth control signal cs8. The turned-on first transistor T1 provides the first reference signal of the first reference signal terminal VREF1 to the first electrode of the drive transistor T0, so that the voltage Vs at the first electrode of the drive transistor T0 is Vref1. The turned-on fourth transistor T4 provides a first initialization signal of the first initialization signal terminal VINIT1 to the second node N2, and the voltage VN2 at the second node N2 is Vinit1. The turned-on third transistor T3 provides the first initialization signal on the second node N2 to the gate of the drive transistor T0, and the voltage Vg at the gate of the drive transistor T0 is Vinit1. The turned-on eighth transistor T8 provides a second initialization signal of the second initialization signal terminal VINIT2 to an anode of the light emitting device L, and the voltage VL at the anode of the light emitting device L is Vinit2. Wherein Vinit1 represents the voltage of the first initialization signal, Vinit2 represents the voltage of the second initialization signal, and Vref1 represents the voltage of the first reference signal.

In the threshold compensation stage F2: the first transistor T1 is turned on under the control of a low level of the first control signal cs1, the second transistor T2 is turned on under the control of a low level of the second control signal cs2, the third transistor T3 is turned on under the control of a low level of the third control signal cs3, the fourth transistor T4 is turned off under the control of a high level of the fifth control signal cs5, the fifth transistor T5 is turned off under the control of a high level of the fourth control signal cs4, the sixth transistor T6 is turned off under the control of a high level of the light emitting signal em, the seventh transistor T7 is turned off under the control of the high level of the light emitting signal em, the eighth transistor T8 is turned on under the control of a low level of the sixth control signal cs6, the eleventh transistor T11 is turned on under the control of a low level of the eighth control signal cs8, and the twelfth transistor T12 is turned on under the control of the low level of the eighth control signal cs8. The turned-on first transistor T1 provides the first reference signal of the first reference signal terminal VREF1 to the first electrode of the drive transistor T0, so that the voltage Vs at the first electrode of the drive transistor T0 is Vref1. The turned-on second transistor T2 makes conduction between the second electrode of the drive transistor T0 and the second node N2, and the turned-on third transistor T3 makes conduction between the second node N2 and the gate of the drive transistor T0. Since the turned-on second transistor T2 and the turned-on third transistor T3 can make the drive transistor T0 form a diode connection mode, the first reference signal input into the first electrode of the drive transistor T0 can be input into the gate of the drive transistor T0 through the drive transistor T0 forming the diode connection mode, and compensate the threshold voltage Vth of the drive transistor T0 to make the voltage Vg of the gate of the drive transistor T0 be (Vref1+Vth), so that the voltage VN2 at the second node N2 and the voltage Vd at the second electrode of the drive transistor T0 are (Vref1+Vth). The turned-on eighth transistor T8 provides the second initialization signal of the second initialization signal terminal VINIT2 to the anode of the light emitting device L, so that the voltage VL at the anode of the light emitting device L is Vinit2. The turned-on twelfth transistor T12 provides the second reference signal of the second reference signal terminal VREF2 to the third node N3, and the turned-on eleventh transistor T11 provides the second reference signal of the third node N3 to the first node N1, so that the voltage VN1 at the first node N1 is Vref2. The second capacitor C2 stabilizes the voltage at the first node N1. Here, Vref2 represents the voltage of the second reference signal, and Vth represents the threshold voltage of the drive transistor T0.

In the data writing stage F3: the first transistor T1 is turned off under the control of a high level of the first control signal cs1, the second transistor T2 is turned off under the control of a high level of the second control signal cs2, the third transistor T3 is turned off under the control of a high level of the third control signal cs3, the fourth transistor T4 is turned off under the control of a high level of the fifth control signal cs5, the fifth transistor T5 is turned on under the control of a low level of the fourth control signal cs4, the sixth transistor T6 is turned off under the control of a high level of the light emitting signal em, the seventh transistor T7 is turned off under the control of the high level of the light emitting signal em, the eighth transistor T8 is turned off under the control of a high level of the sixth control signal cs6, the eleventh transistor T11 is turned off under the control of a high level of the eighth control signal cs8, and the twelfth transistor T12 is turned off under the control of the high level of the eighth control signal cs8. The turned-on fifth transistor T5 provides the data voltage signal of the data signal terminal DA to the first node N1, and the first capacitor C1 couples the data voltage signal of the first node N1 to the gate of the drive transistor T0, so that the voltage Vg of the gate of the drive transistor T0 is (Vref1+Vth+Vda−Vref2). The second capacitor C2 stabilizes the voltage at the first node N1. Here, Vda represents the vsoltage of the data voltage signal.

In the light emitting stage F4: the first transistor T1 is turned off under the control of a high level of the first control signal cs1, the second transistor T2 is turned off under the control of a high level of the second control signal cs2, the third transistor T3 is turned off under the control of a high level of the third control signal cs3, the fourth transistor T4 is turned on under the control of a low level of the fifth control signal cs5, the fifth transistor T5 is turned off under the control of a high level of the sixth control signal cs4, the sixth transistor T6 is turned on under the control of a low level of the light emitting signal em, the seventh transistor T7 is turned on under the control of the low level of the light emitting signal em, the eighth transistor T8 is turned off under the control of a high level of the sixth control signal cs6, the eleventh transistor T11 is turned off under the control of a high level of the eighth control signal cs8, and the twelfth transistor T12 is turned off under the control of the high level of the eighth control signal cs8. The turned-on fourth transistor T4 provides the first initialization signal of the first initialization signal terminal VINIT1 to the second node N2, so that the voltage VN2 at the second node N2 is Vinit1. The turned-on sixth transistor T6 provides the first power supply voltage Vdd of the first power supply terminal VDD to the first electrode of the drive transistor T0, so that the voltage Vs at the first electrode of the drive transistor T0 is Vdd. The turned-on seventh transistor T7 make conduction between the second electrode of the drive transistor T0 and the light emitting device L to drive the light emitting device L to emit light. Then, the drive transistor T0 operates in a saturation region, and the drive current I generated by the drive transistor can be expressed as

$$I = \frac{k}{2} * {( Vgs - Vth )}^{2} = \frac{k}{2} * {( Vref 1 + Vda - Vref 2 - Vdd )}^{2} .$$

### Here,

$$k = {μ C}_{ox} \frac{W}{L} ,$$

μ represents a mobility of the drive transistor T0, Cox represents a capacitance per unit area of a gate insulating layer of the drive transistor T0, and W/L represents a channel width to length ratio of the drive transistor T0.

Exemplarily, the first control signal terminal CS1, the third control signal terminal CS3, and the sixth control signal terminal CS6 may be the same one signal terminal. In this way, the number of signal lines can be reduced to reduce the space occupied by the wiring.

Exemplarily, the second control signal terminal CS2 and the eighth control signal terminal CS8 may be the same one signal terminal. In this way, the number of signal lines can be reduced to reduce the space occupied by the wiring.

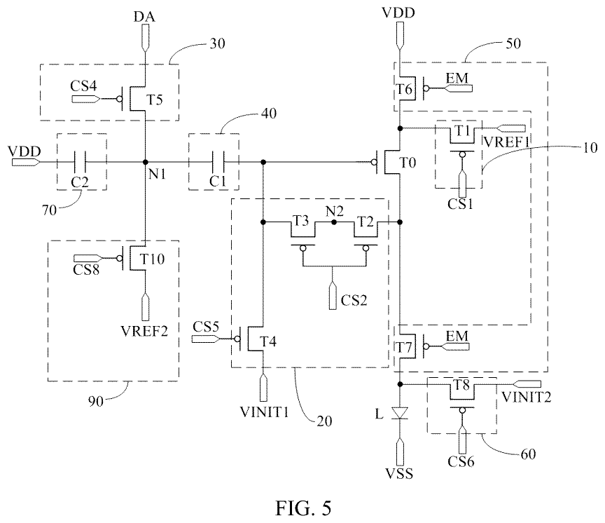

A schematic diagram of some other structures of the pixel circuit is provided by an embodiment of the present disclosure, as shown in FIG. 5, which is deformed with respect to the implementations in the above-described embodiments. Only the differences between the present embodiment and the above-described embodiments are described below, and the similarities are not repeated herein.

in the embodiments of the present disclosure, as shown in FIG. 5, the second compensation circuit 20 further includes: a fourth transistor T4; wherein a gate of the fourth transistor T4 is coupled to the fifth control signal terminal CS5, a first electrode of the fourth transistor T4 is coupled to the gate of the drive transistor T0, and a second electrode of the fourth transistor T4 is coupled to the first initialization signal terminal VINIT1.

Exemplarily, as shown in FIG. 5, the second control signal terminal CS2 and the third control signal terminal CS3 may be the same one signal terminal. The gate of the third transistor T3 is coupled to the second control signal terminal CS2. In this way, the number of signal lines can be reduced to reduce the space occupied by the wiring.

In the embodiments of the present disclosure, as shown in FIG. 5, the third reset circuit 90 includes: a tenth transistor T10; wherein a gate of the tenth transistor T10 is coupled to the eighth control signal terminal CS8, a first electrode of the tenth transistor T10 is coupled to the first node N1, and a second electrode of the tenth transistor T10 is coupled to the second reference signal terminal VREF2.

Exemplarily, the tenth transistor T10 may be turned on under the control of an effective level of the eighth control signal transmitted at the eighth control signal terminal CS8 and may be turned off under the control of an ineffective level of the eighth control signal. For example, the tenth transistor T10 may be provided as an N-type transistor, so that the effective level of the eighth control signal is a high level and the ineffective level of the eighth control signal is a low level. Alternatively, the tenth transistor T10 may be provided as a P-type transistor, so that the effective level of the eighth control signal is a low level and the ineffective level of the eighth control signal is a high level.

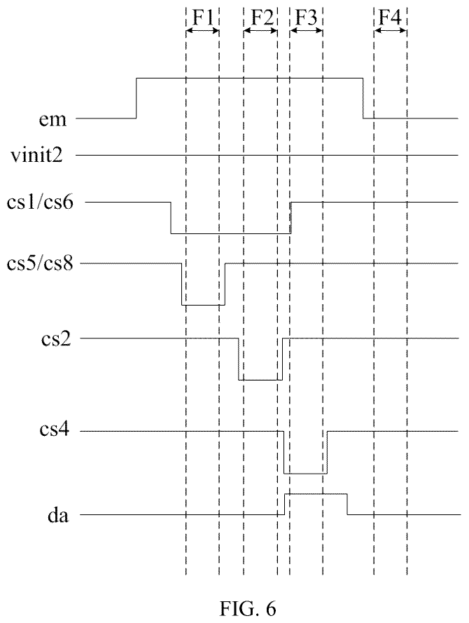

The following is a description of the operating process of the pixel circuit provided by the embodiments of the present disclosure, using the pixel circuit shown in FIG. 5 as an example, in conjunction with the timing chart of signals shown in FIG. 6.

Here, as shown in FIG. 6, em represents a light emitting signal of the light emitting control signal terminal EM, cs1 represents a first control signal of the first control signal terminal CS1, cs2 represents a second control signal of the second control signal terminal CS2, cs4 represents a fourth control signal of the fourth control signal terminal CS4, cs5 represents a fifth control signal of the fifth control signal terminal CS5, cs6 represents a sixth control signal of the sixth control signal terminal CS6, cs8 represents an eighth control signal of the eighth control signal terminal CS8, da represents a data voltage signal of the data signal terminal DA, and vinit2 represents a second initialization signal of the second initialization signal terminal VINIT2.

In the reset stage F1: the first transistor T1 is turned on under the control of a low level of the first control signal cs1, the second transistor T2 is turned off under the control of a high level of the second control signal cs2, the third transistor T3 is turned off under the control of the high level of the second control signal cs2, the fourth transistor T4 is turned on under the control of a low level of the fifth control signal cs5, the fifth transistor T5 is turned off under the control of a high level of the control signal cs4, the sixth transistor T6 is turned off under the control of a high level of the light emitting signal em, the seventh transistor T7 is turned off under the control of the high level of the light emitting signal em, the eighth transistor T8 is turned on under the control of a low level of the sixth control signal cs6, and the tenth transistor T10 is turned on under the control of a low level of the eighth control signal cs8. The turned-on first transistor T1 provides the first reference signal of the first reference signal terminal VREF1 to the first electrode of the drive transistor T0, so that the voltage Vs at the first electrode of the drive transistor T0 is Vref1. The turned-on fourth transistor T4 provides the first initialization signal of the first initialization signal terminal VINIT1 to the gate of the drive transistor T0, so that the voltage Vg at the gate of the drive transistor T0 is Vinit1. The turned-on eighth transistor T8 provides the second initialization signal of the second initialization signal terminal VINIT2 to the anode of the light emitting device L, so that the voltage VL at the anode of the light emitting device L is Vinit2. The turned-on tenth transistor T10 provides the second reference signal of the second reference signal terminal VREF2 to the first node N1, so that the voltage VN1 at the first node N1 is Vref2. The second capacitor C2 stabilizes the voltage at the first node N1.

In the threshold compensation stage F2: the first transistor T1 is turned on under the control of a low level of the first control signal cs1, the second transistor T2 is turned on under the control of a low level of the second control signal cs2, the third transistor T3 is turned on under the control of the low level of the second control signal cs2, the fourth transistor T4 is turned off under the control of a high level of the fifth control signal cs5, the fifth transistor T5 is turned off under the control of a high level of the fourth control signal cs4, the sixth transistor T6 is turned off under the control of a high level of the light emitting signal em, the seventh transistor T7 is turned off under the control of the high level of the light emitting signal em, the eighth transistor T8 is turned on under the control of a low level of the sixth control signal cs6, and the tenth transistor T10 is turned off under the control of the high level of the eighth control signal cs8. The turned-on first transistor T1 provides the first reference signal of the first reference signal terminal VREF1 to the first electrode of the drive transistor T0, so that the voltage Vs at the first electrode of the drive transistor T0 is Vref1. The turned-on second transistor T2 makes conduction between the second electrode of the drive transistor T0 and the second node N2, and the turned-on third transistor T3 makes conduction between the second node N2 and the gate of the drive transistor T0. Since the turned-on second transistor T2 and the turned-on third transistor T3 can make the drive transistor T0 form a diode connection mode, the first reference signal input into the first electrode of the drive transistor T0 can be input into the gate of the drive transistor T0 through the drive transistor T0 forming the diode connection mode, and compensate the threshold voltage Vth of the drive transistor T0 to make the voltage Vg of the gate of the drive transistor T0 be (Vref1+Vth), so that the voltage VN2 at the second node N2 and the voltage Vd of the second electrode of the drive transistor T0 are (Vref1+Vth). The turned-on eighth transistor T8 provides the second initialization signal of the second initialization signal terminal VINIT2 to the anode of the light emitting device L, so that the voltage VL at the anode of the light emitting device L is Vinit2. The second capacitor C2 stabilizes the voltage at the first node N1.

In the data writing stage F3: the first transistor T1 is turned off under the control of a high level of the first control signal cs1, the second transistor T2 is turned off under the control of a high level of the second control signal cs2, the third transistor T3 is turned off under the control of the high level of the second control signal cs2, the fourth transistor T4 is turned off under the control of a high level of the fifth control signal cs5, the fifth transistor T5 is turned on under the control of a low level of the fourth control signal cs4, the sixth transistor T6 is turned off under the control of a high level of the light emitting signal em, the seventh transistor T7 is turned off under the control of the high level of the light emitting signal em, the eighth transistor T8 is turned off under the control of a high level of the sixth control signal cs6, and the tenth transistor T10 is turned off under the control of the high level of the eighth control signal cs8. The turned-on fifth transistor T5 provides the data voltage signal of the data signal terminal DA to the first node N1, and the first capacitor C1 couples the data voltage signal of the first node N1 to the gate of the drive transistor T0, so that the voltage Vg of the gate of the drive transistor T0 is (Vref1+Vth+Vda−Vref2). The second capacitor C2 stabilizes the voltage at the first node N1.

In the light emitting stage F4: the first transistor T1 is turned off under the control of a high level of the first control signal cs1, the second transistor T2 is turned off under the control of a high level of the second control signal cs2, the third transistor T3 is turned off under the control of the high level of the second control signal cs2, the fourth transistor T4 is turned off under the control of a high level of the fifth control signal cs5, the fifth transistor T5 is turned off under the control of a high level of the fourth control signal cs4, the sixth transistor T6 is turned on under the control of a low level of the light emitting signal em, the seventh transistor T7 is turned on under the control of the low level of the light emitting signal em, the eighth transistor T8 is turned off under the control of a high level of the sixth control signal cs6, and the tenth transistor T10 is turned off under the control of a high level of the eighth control signal cs8. The turned-on sixth transistor T6 provides the first power supply voltage Vdd of the first power supply terminal VDD to the first electrode of the drive transistor T0, so that the voltage Vs at the first electrode of the drive transistor T0 is Vdd, and the turned-on seventh transistor T7 makes conduction between the second electrode of the drive transistor T0 and the light emitting device L to drive the light emitting device L to emit light. Then, the drive transistor T0 operates in a saturation region, and the drive current I generated therefrom may be expressed as

$$I = \frac{k}{2} * {( Vgs - Vth )}^{2} = \frac{k}{2} * {( Vref 1 + Vda - Vref 2 - Vdd )}^{2} .$$

Exemplarily, the first control signal terminal CS1 and the sixth control signal terminal CS6 may be the same one signal terminal. In this way, the number of signal lines can be reduced to reduce the space occupied by the wiring.

Exemplarily, the fifth control signal terminal CS5 and the eighth control signal terminal CS8 may be the same one signal terminal. In this way, the number of signal lines can be reduced to reduce the space occupied by the wiring.

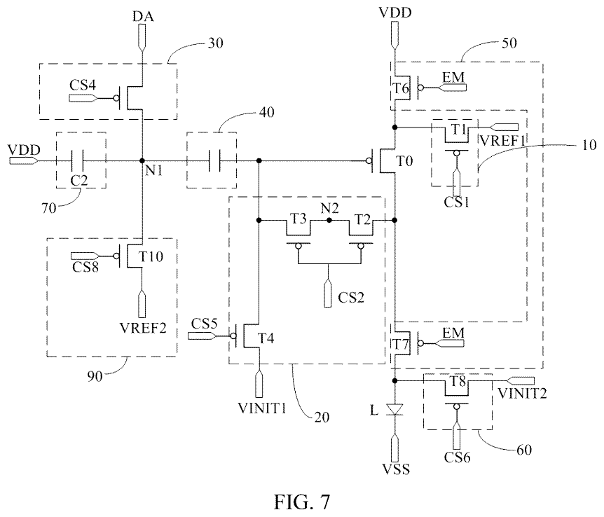

A schematic diagram of yet some other structures of the pixel circuit is provided by an embodiment of the present disclosure, as shown in FIG. 7, which is deformed with respect to the implementations in the above-described embodiments. Only the differences between the present embodiment and the above-described embodiments are described below, and the similarities are not repeated herein.

Exemplarily, as shown in FIG. 7, the second control signal terminal CS2 and the eighth control signal terminal CS8 may be the same one signal terminal. The gate of the tenth transistor T10 is coupled to the eighth control signal terminal CS8. In this way, the number of signal lines is reduced to reduce the space occupied by the wiring.

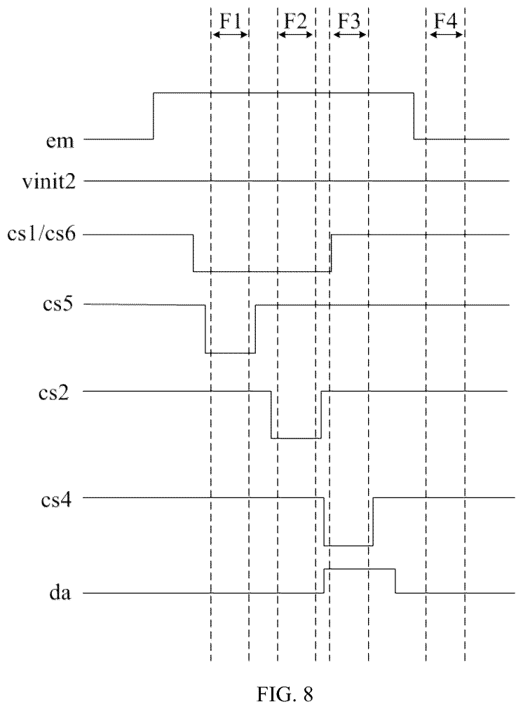

The following is a description of the operating process of the pixel circuit provided by the embodiment of the present disclosure, using the pixel circuit shown in FIG. 7 as an example, in conjunction with the timing chart of signals shown in FIG. 8.

Here, as shown in FIG. 8, em represents a light emitting signal of the light emitting control signal terminal EM, cs1 represents a first control signal of the first control signal terminal CS1, cs2 represents a second control signal of the second control signal terminal CS2, cs4 represents a fourth control signal of the fourth control signal terminal CS4, cs5 represents a fifth control signal of the fifth control signal terminal CS5, cs6 represents a sixth control signal of the sixth control signal terminal CS6, da represents a data voltage signal of the data signal terminal DA, and vinit2 represents a second initialization signal of the second initialization signal terminal VINIT2.

In the reset stage F1: the first transistor T1 is turned on under the control of a low level of the first control signal cs1, the second transistor T2 is turned off under the control of a high level of the second control signal cs2, the third transistor T3 is turned off under the control of the high level of the second control signal cs2, the fourth transistor T4 is turned on under the control of a low level of the fifth control signal cs5, the fifth transistor T5 is turned off under the control of a high level of the control signal cs4, the sixth transistor T6 is turned off under the control of a high level of the light emitting signal em, the seventh transistor T7 is turned off under the control of the high level of the light emitting signal em, the eighth transistor T8 is turned on under the control of a low level of the sixth control signal cs6, and the tenth transistor T10 is turned off under the control of the high level of the second control signal cs2. The turned-on first transistor T1 provides the first reference signal of the first reference signal terminal VREF1 to the first electrode of the drive transistor T0, so that the voltage Vs at the first electrode of the drive transistor T0 is Vref1. The turned-on fourth transistor T4 provides the first initialization signal of the first initialization signal terminal VINIT1 to the gate of the drive transistor T0, so that the voltage Vg at the gate of the drive transistor T0 is Vinit1. The turned-on eighth transistor T8 provides the second initialization signal of the second initialization signal terminal VINIT2 to the anode of the light emitting device L, so that the voltage VL at the anode of the light emitting device L is Vinit2.

In the threshold compensation stage F2: the first transistor T1 is turned on under the control of a low level of the first control signal cs1, the second transistor T2 is turned on under the control of a low level of the second control signal cs2, the third transistor T3 is turned on under the control of the low level of the second control signal cs2, the fourth transistor T4 is turned off under the control of a high level of the fifth control signal cs5, the fifth transistor T5 is turned off under the control of a high level of the fourth control signal cs4, the sixth transistor T6 is turned off under the control of a high level of the light emitting signal em, the seventh transistor T7 is turned off under the control of the high level of the light emitting signal em, the eighth transistor T8 is turned on under the control of a low level of the sixth control signal cs6, and the tenth transistor T10 is turned on under the control of the low level of the second control signal cs2. The turned-on first transistor T1 provides the first reference signal of the first reference signal terminal VREF1 to the first electrode of the drive transistor T0, so that the voltage Vs at the first electrode of the drive transistor T0 is Vref1. The turned-on second transistor T2 makes conduction between the second electrode of the drive transistor T0 and the second node N2, and the turned-on third transistor T3 makes conduction between the second node N2 and the gate of the drive transistor T0. Since the turned-on second transistor T2 and the turned-on third transistor T3 can make the drive transistor T0 form a diode connection mode, the first reference signal input into the first electrode of the drive transistor T0 can be input into the gate of the drive transistor T0 through the drive transistor T0 forming the diode connection mode, and compensate the threshold voltage Vth of the drive transistor T0, to make the voltage Vg of the gate of the drive transistor T0 be (Vref1+Vth), so that the voltage VN2 at the second node N2 and the voltage Vd of the second electrode of the drive transistor T0 are (Vref1+Vth). The turned-on eighth transistor T8 provides the second initialization signal terminal VINIT2 of the second initialization signal terminal to the anode of the light emitting device L, so that the voltage VL at the anode of the light emitting device L is Vinit2. The turned-on tenth transistor T10 provides the second reference signal of the second reference signal terminal VREF2 to the first node N1, so that the voltage VN1 at the first node N1 is Vref2. The second capacitor C2 stabilizes the voltage at the first node N1.

In the data writing stage F3: the first transistor T1 is turned off under the control of a high level of the first control signal cs1, the second transistor T2 is turned off under the control of a high level of the second control signal cs2, the third transistor T3 is turned off under the control of the high level of the second control signal cs2, the fourth transistor T4 is turned off under the control of a high level of the fifth control signal cs5, the fifth transistor T5 is turned on under the control of a low level of the fourth control signal cs4, the sixth transistor T6 is turned off under the control of a high level of the light emitting signal em, the seventh transistor T7 is turned off under the control of the high level of the light emitting signal em, the eighth transistor T8 is turned off under the control of a high level of the sixth control signal cs6, and the tenth transistor T10 is turned off under the control of the high level of the eighth control signal cs8. The turned-on fifth transistor T5 provides the data voltage signal of the data signal terminal DA to the first node N1, and the first capacitor C1 couples the data voltage signal of the first node N1 to the gate of the drive transistor T0, so that the voltage Vg of the gate of the drive transistor T0 is (Vref1+Vth+Vda−Vref2). The second capacitor C2 stabilizes the voltage at the first node N1.

In the light emitting stage F4: the first transistor T1 is turned off under the control of a high level of the first control signal cs1, the second transistor T2 is turned off under the control of a high level of the second control signal cs2, the third transistor T3 is turned off under the control of the high level of the second control signal cs2, the fourth transistor T4 is turned off under the control of a high level of the fifth control signal cs5, the fifth transistor T5 is turned off under the control of a high level of the fourth control signal cs4, the sixth transistor T6 is turned on under the control of a low level of the light emitting signal em, the seventh transistor T7 is turned on under the control of the low level of the light emitting signal em, the eighth transistor T8 is turned off under the control of a high level of the sixth control signal cs6, and the tenth transistor T10 is turned off under the control of a high level of the eighth control signal cs8. The turned-on sixth transistor T6 provides the first power supply voltage Vdd of the first power supply terminal VDD to the first electrode of the drive transistor T0, so that the voltage Vs at the first electrode of the drive transistor T0 is Vdd, and the turned-on seventh transistor T7 makes conduction between the second electrode of the drive transistor T0 and the light emitting device L to drive the light emitting device L to emit light. Then, the drive transistor T0 operates in a saturation region, and the drive current I generated therefrom may be expressed as

$$I = \frac{k}{2} * {( Vgs - Vth )}^{2} = \frac{k}{2} * {( Vref 1 + Vda - Vref 2 - Vdd )}^{2} .$$

Exemplarily, the first control signal terminal CS1 and the sixth control signal terminal CS6 may be the same one signal terminal. In this way, the number of signal lines can be reduced to reduce the space occupied by the wiring.

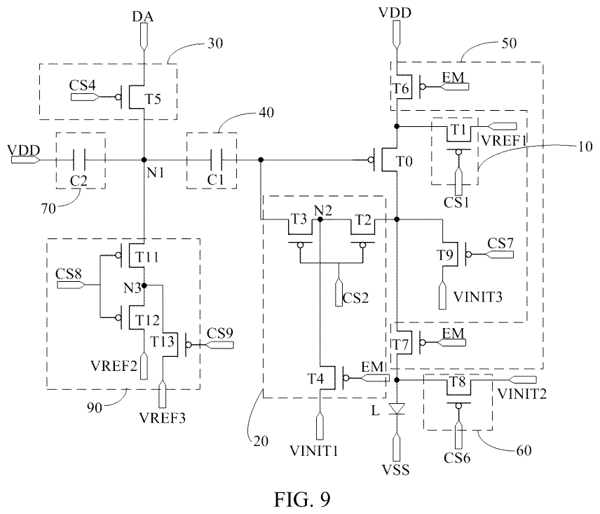

A schematic diagram of yet some other structures of the pixel circuit is provided by an embodiment of the present disclosure, as shown in FIG. 9, which is deformed with respect to the implementations in the above-described embodiments. Only the differences between the present embodiment and the above-described embodiments are described below, and the similarities are not repeated herein.

In the embodiment of the present disclosure, as shown in FIG. 9, the fifth control signal terminal CS5 and the light emitting control signal terminal EM may be the same one signal terminal. In this way, the number of signal lines can be reduced to reduce the space occupied by the wiring.

In the embodiment of the present disclosure, as shown in FIG. 9, the pixel circuit further includes: a second reset circuit 80, coupled to the second electrode of the drive transistor T0, and configured, in response to a signal of a seventh control signal terminal CS7, to provide a signal of the third initialization signal terminal VINIT3 to the second electrode of the drive transistor T0.

In the embodiment of the present disclosure, as shown in FIG. 9, the second reset circuit 80 includes: a ninth transistor T9; wherein a gate of the ninth transistor T9 is coupled to the seventh control signal terminal CS7, a first electrode of the ninth transistor T9 is coupled to the second electrode of the drive transistor T0, and a second electrode of the ninth transistor T9 is coupled to the third initialization signal terminal VINIT3.

Exemplarily, the ninth transistor T9 may be turned on under the control of an effective level of the seventh control signal transmitted at the seventh control signal terminal CS7, and may be turned off under the control of an ineffective level of the seventh control signal. For example, the ninth transistor T9 may be provided as an N-type transistor, so that the effective level of the seventh control signal is a high level and the ineffective level of the seventh control signal is a low level. Alternatively, the ninth transistor T9 may be provided as a P-type transistor, so that the effective level of the seventh control signal is a low level and the ineffective level of the seventh control signal is a high level.

In the embodiment of the present disclosure, as shown in FIG. 9, the third reset circuit 90 further includes: a thirteenth transistor T13; wherein a gate of the thirteenth transistor T13 is coupled to the ninth control signal terminal CS9, a first electrode of the thirteenth transistor T13 is coupled to the third node N3, and a second electrode of the thirteenth transistor T13 is coupled to the third reference signal terminal VREF3.

Exemplarily, the thirteenth transistor T13 may be turned on under the control of an effective level of the ninth control signal transmitted at the ninth control signal terminal CS9 and may be turned off under the control of an ineffective level of the ninth control signal. For example, the thirteenth transistor T13 may be provided as an N-type transistor, so that the effective level of the ninth control signal is a high level and the ineffective level of the ninth control signal is a low level. Alternatively, the thirteenth transistor T13 may be provided as a P-type transistor, so that the effective level of the ninth control signal is a low level and the ineffective level of the ninth control signal is a high level.

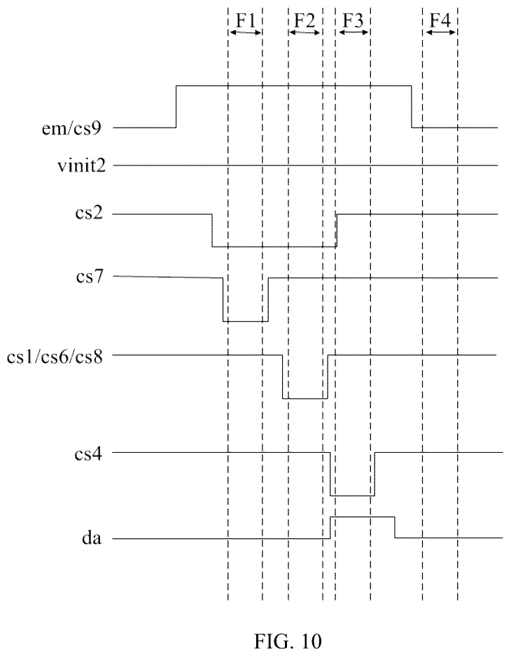

The following is a description of the operating process of the pixel circuit provided by the embodiment of the present disclosure, using the pixel circuit shown in FIG. 9 as an example, in conjunction with the timing chart of signals shown in FIG. 10.

Here, as shown in FIG. 10, em represents a light emitting signal of the light emitting control signal terminal EM, cs1 represents a first control signal of the first control signal terminal CS1, cs2 represents a second control signal of the second control signal terminal CS2, cs4 represents a fourth control signal of the fourth control signal terminal CS4, cs5 represents a fifth control signal of the fifth control signal terminal CS5, cs6 represents a sixth control signal of the sixth control signal terminal CS6, cs7 represents a seventh control signal of the seventh control signal terminal CS7, cs8 represents an eighth control signal of the eighth control signal terminal CS8, cs9 represents a ninth control signal of the ninth control signal terminal CS9, da represents a data voltage signal of the data signal terminal DA, and vinit2 represents a second initialization signal of the second initialization signal terminal VINIT2.

In the reset stage F1: the first transistor T1 is turned off under the control of a high level of the first control signal cs1, the second transistor T2 is turned on under the control of a low level of the second control signal cs2, the third transistor T3 is turned on under the control of the low level of the second control signal cs2, the fourth transistor T4 is turned off under the control of a high level of the light emitting signal em, the fifth transistor T5 is turned off under the control of a high level of the fourth control signal cs4, the sixth transistor T6 is turned off under the control of a high level of the light emitting signal em, the seventh transistor T7 is turned off under the control of the high level of the light emitting signal em, the eighth transistor T8 is turned off under the control of a high level of the sixth control signal cs6, the ninth transistor T9 is turned on under the control of a low level of the seventh control signal cs7, the eleventh transistor T11 is turned off under the control of a high level of the eighth control signal cs8, the twelfth transistor T12 is turned off under the control of the high level of the eighth control signal cs8, and the thirteenth transistor T13 is turned off under the control of a high level of the ninth control signal cs9. The turned-on ninth transistor T9 provides the third initialization signal of the third initialization signal terminal VINIT3 to the second electrode of the drive transistor T0, so that the voltage Vd at the second electrode of the drive transistor T0 is Vinit3. The turned-on second transistor T2 and the turned-on third transistor T3 provide the third initialization signal of the second electrode of the drive transistor T0 to the gate of the drive transistor T0, so that the voltage Vg at the gate of the drive transistor T0 is Vinit3. Here, Vinit3 represents a voltage of the third initialization signal.

In the threshold compensation stage F2: the first transistor T1 is turned on under the control of a low level of the first control signal cs1, the second transistor T2 is turned on under the control of a low level of the second control signal cs2, the third transistor T3 is turned on under the control of a low level of the second control signal cs2, the fourth transistor T4 is turned off under the control of a high level of the light emitting signal em, the fifth transistor T5 is turned off under the control of a high level of the fourth control signal cs4, the sixth transistor T6 is turned off under the control of the high level of the light emitting signal em, the seventh transistor T7 is turned off under the control of the high level of the light emitting signal em, the eighth transistor T8 is turned on under the control of a low level of the sixth control signal cs6, the ninth transistor T9 is turned off under the control of a high level of the seventh control signal cs7, the eleventh transistor T11 is turned on under the control of a low level of the eighth control signal cs8, the twelfth transistor T12 is turned on under the control of the low level of the eighth control signal cs8, and the thirteenth transistor T13 is turned off under the control of a high level of the ninth control signal cs9. The turned-on first transistor T1 provides the first reference signal of the first reference signal terminal VREF1 to the first electrode of the drive transistor T0, so that the voltage Vs at the first electrode of the drive transistor T0 is Vref1. The turned-on second transistor T2 makes conduction between the second electrode of the drive transistor T0 and the second node N2, and the turned-on third transistor T3 makes conduction between the second node N2 and the gate of the drive transistor T0. Since the turned-on second transistor T2 and the turned-on third transistor T3 can make the drive transistor T0 form a diode connection mode, the first reference signal input into the first electrode of the drive transistor T0 can be input into the gate of the drive transistor T0 through the drive transistor T0 forming the diode connection mode, and compensate the threshold voltage Vth of the drive transistor T0 to make the voltage Vg of the gate of the drive transistor T0 be (Vref1+Vth), so that the voltage VN2 at the second node N2 and the voltage Vd at the second electrode of the drive transistor T0 are (Vref1+Vth). The turned-on eighth transistor T8 provides the second initialization signal of the second initialization signal terminal VINIT2 to the anode of the light emitting device L, so that the voltage VL at the anode of the light emitting device L is Vinit2. The turned-on twelfth transistor T12 provides the second reference signal of the second reference signal terminal VREF2 to the third node N3, and the turned-on eleventh transistor T11 provides the second reference signal of the third node N3 to the first node N1, so that the voltage VN1 at the first node N1 is Vref2. The second capacitor C2 stabilizes the voltage at the first node N1.

In the data writing stage F3: the first transistor T1 is turned off under the control of a high level of the first control signal cs1, the second transistor T2 is turned off under the control of a high level of the second control signal cs2, the third transistor T3 is turned off under the control of the high level of the second control signal cs2, the fourth transistor T4 is turned off under the control of a high level of the light emitting signal em, the fifth transistor T5 is turned on under the control of a low level of the fourth control signal cs4, the sixth transistor T6 is turned off under the control of the high level of the light emitting signal em, the seventh transistor T7 is turned off under the control of the high level of the light emitting signal em, the eighth transistor T8 is turned off under the control of a high level of the sixth control signal cs6, the ninth transistor T9 is turned off under the control of a high level of the seventh control signal cs7, and the eleventh transistor T11 is turned off under the control of a high level of the eighth control signal cs8, the twelfth transistor T12 is turned off under the control of the high level of the eighth control signal cs8, and the thirteenth transistor T13 is turned off under the control of the high level of the ninth control signal cs9. The turned-on fifth transistor T5 provides the data voltage signal of the data signal terminal DA to the first node N1, and the first capacitor C1 couples the data voltage signal of the first node N1 to the gate of the drive transistor T0, so that the voltage Vg of the gate of the drive transistor T0 is (Vref1+Vth+Vda-Vref2). The second capacitor C2 stabilizes the voltage at the first node N1.

In the light emitting stage F4: the first transistor T1 is turned off under the control of a high level of the first control signal cs1, the second transistor T2 is turned off under the control of a high level of the second control signal cs2, the third transistor T3 is turned off under the control of the high level of the second control signal cs2, the fourth transistor T4 is turned on under the control of a low level of the light emitting signal em, the fifth transistor T5 is turned off under the control of a high level of the fourth control signal cs4, the sixth transistor T6 is turned on under the control of the low level of the light emitting signal em, the seventh transistor T7 is turned on under the control of the low level of the light emitting signal em, the eighth transistor T8 is turned off under the control of a high level of the sixth control signal cs6, the ninth transistor T9 is turned off under the control of a high level of the seventh control signal cs7, the eleventh transistor T11 is turned off under the control of the high level of the eighth control signal cs8, the twelfth transistor T12 is turned off under the control of the high level of the eighth control signal cs8, and the thirteenth transistor T13 is turned on under the control of a low level of the ninth control signal cs9. The turned-on fourth transistor T4 provides the first initialization signal of the first initialization signal terminal VINIT1 to the second node N2, so that the voltage VN2 at the second node N2 is Vinit1. The turned-on thirteenth transistor T13 provides the third reference signal of the third reference signal terminal VREF3 to the third node N3, so that the voltage VN3 at the third node N3 is Vref3. The turned-on sixth transistor T6 provides the first power supply voltage Vdd of the first power supply terminal VDD to the first electrode of the drive transistor T0, so that the voltage Vs at the first electrode of the drive transistor T0 is Vdd. The turned-on seventh transistor T7 makes conduction between the second electrode of the drive transistor T0 and the light emitting device L to drive the light emitting device L to emit light. Then, the drive transistor T0 operates in a saturation region, and the drive current I generated therefrom can be expressed as

$$I = \frac{k}{2} * {( Vgs - Vth )}^{2} = \frac{k}{2} * {( Vref 1 + Vda - Vref 2 - Vdd )}^{2} .$$

### Here,

$$k = {μ C}_{ox} \frac{W}{L} ,$$

μ represents a mobility of the drive transistor T0, Cox represents a capacitance per unit area of a gate insulating layer of the drive transistor T0, and W/L represents a channel width to length ratio of the drive transistor T0.

Exemplarily, the first control signal terminal CS1, the sixth control signal terminal CS6, and the eighth control signal terminal CS8 may be the same one signal terminal. In this way, the number of signal lines can be reduced to reduce the space occupied by the wiring.

Exemplarily, the light emitting control signal terminal EM and the ninth control signal terminal CS9 may be the same one signal terminal. In this way, the number of signal lines can be reduced to reduce the space occupied by the wiring.

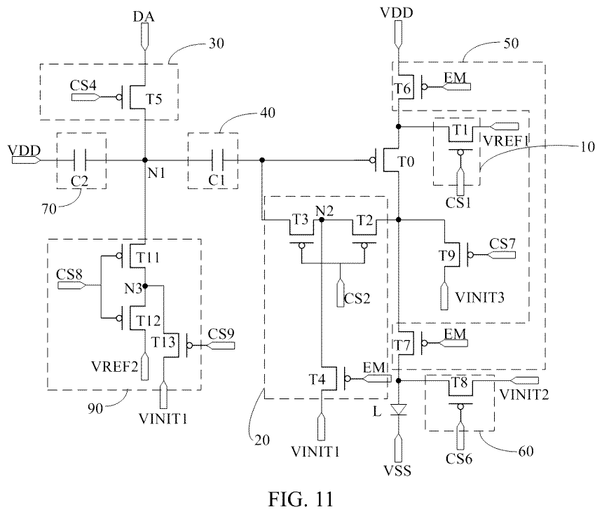

A schematic diagram of yet some other structures of the pixel circuit is provided by an embodiment of the present disclosure, as shown in FIG. 11, which is deformed with respect to the implementations in the above-described embodiments. Only the differences between the present embodiment and the above-described embodiments are described below, and the similarities are not repeated herein.

Exemplarily, as shown in FIG. 11, the third reference signal terminal and the first initialization signal terminal VINIT1 may be the same one signal terminal. In this way, the number of signal lines can be reduced to reduce the space occupied by the wiring.

A timing chart of signals corresponding to the pixel circuit shown in FIG. 11 may be as shown in FIG. 10. Moreover, the specific work process of the pixel circuit shown in FIG. 11 in conjunction with the timing chart of signals shown in FIG. 10 may be described with reference to the description of the above embodiments and will not be repeated herein.

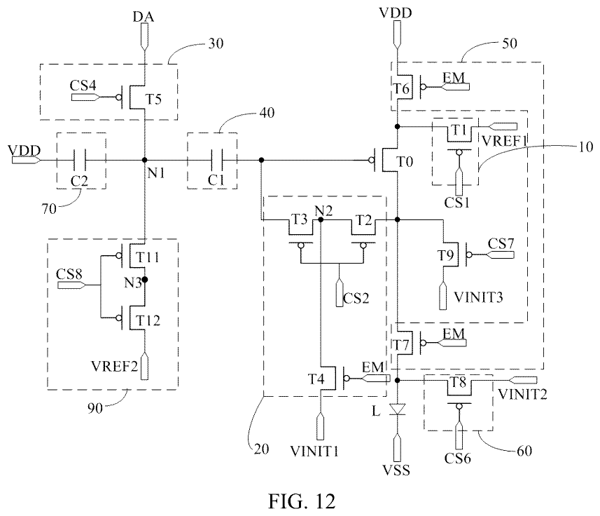

A schematic diagram of yet some other structures of the pixel circuit is provided by an embodiment of the present disclosure, as shown in FIG. 12, which is deformed with respect to the implementations in the above-described embodiments. Only the differences between the present embodiment and the above-described embodiments are described below, and the similarities are not repeated herein.

The following describes the operating process of the pixel circuit provided in the embodiment of the present disclosure, using the pixel circuit shown in FIG. 12 as an example, in conjunction with the timing chart of signals shown in FIG. 10.

In the reset stage F1: the first transistor T1 is turned off under the control of a high level of the first control signal cs1, the second transistor T2 is turned on under the control of a low level of the second control signal cs2, the third transistor T3 is turned on under the control of the low level of the second control signal cs2, the fourth transistor T4 is turned off under the control of a high level of the light emitting signal em, the fifth transistor T5 is turned off under the control of a high level of the fourth control signal cs4, the sixth transistor T6 is turned off under the control of the high level of the light emitting signal em, the seventh transistor T7 is turned off under the control of the high level of the light emitting signal em, the eighth transistor T8 is turned off under the control of a high level of the sixth control signal cs6, the ninth transistor T9 is turned on under the control of a low level of the seventh control signal cs7, the eleventh transistor T11 is turned off under the control of a high level of the eighth control signal cs8, and the twelfth transistor T12 is turned off under the control of the high level of the eighth control signal cs8. The turned-on ninth transistor T9 provides the third initialization signal of the third initialization signal terminal VINIT3 to the second electrode of the drive transistor T0, so that the voltage Vd at the second electrode of the drive transistor T0 is Vinit3.

The turned-on second transistor T2 and the turned-on third transistor T3 provide the third initialization signal of the second electrode of the drive transistor T0 to the gate of the drive transistor T0, so that the voltage Vg at the gate of the drive transistor T0 is Vinit3.

In the threshold compensation stage F2: the first transistor T1 is turned on under the control of a low level of the first control signal cs1, the second transistor T2 is turned on under the control of a low level of the second control signal cs2, the third transistor T3 is turned on under the control of the low level of the second control signal cs2, the fourth transistor T4 is turned off under the control of a high level of the light emitting signal em, the fifth transistor T5 is turned off under the control of a high level of the fourth control signal cs4, the sixth transistor T6 is turned off under the control of the high level of the light emitting signal em, the seventh transistor T7 is turned off under the control of the high level of the light emitting signal em, the eighth transistor T8 is turned on under the control of a low level of the sixth control signal cs6, the ninth transistor T9 is turned off under the control of a high level of the seventh control signal cs7, the eleventh transistor T11 is turned on under the control of a low level of the eighth control signal cs8, and the twelfth transistor T12 is turned on under the control of the low level of the eighth control signal cs8. The turned-on first transistor T1 provides the first reference signal of the first reference signal terminal VREF1 to the first electrode of the drive transistor T0, so that the voltage Vs at the first electrode of the drive transistor T0 is Vref1. The turned-on second transistor T2 makes conduction between the second electrode of the drive transistor T0 and the second node N2, and the turned-on third transistor T3 makes conduction between the second node N2 and the gate of the drive transistor T0. Since the turned-on second transistor T2 and the turned-on third transistor T3 can make the drive transistor T0 form a diode connection mode, the first reference signal input into the first electrode of the drive transistor T0 can be input into the gate of the drive transistor T0 through the drive transistor T0 forming the diode connection mode, and compensate the threshold voltage Vth of the drive transistor T0 to make the voltage Vg of the gate of the drive transistor T0 be (Vref1+Vth), so that the voltage VN2 at the second node N2 and the voltage Vd at the second electrode of the drive transistor T0 are (Vref1+Vth). The turned-on eighth transistor T8 provides the second initialization signal of the second initialization signal terminal VINIT2 to the anode of the light emitting device L, so that the voltage VL at the anode of the light emitting device L is Vinit2. The turned-on twelfth transistor T12 provides the second reference signal of the second reference signal terminal VREF2 to the third node N3, and the turned-on eleventh transistor T11 provides the second reference signal of the third node N3 to the first node N1, so that the voltage VN1 at the first node N1 is Vref2. The second capacitor C2 stabilizes the voltage at the first node N1.

In the data writing stage F3: the first transistor T1 is turned off under the control of a high level of the first control signal cs1, the second transistor T2 is turned off under the control of a high level of the second control signal cs2, the third transistor T3 is turned off under the control of the high level of the second control signal cs2, the fourth transistor T4 is turned off under the control of a high level of the light emitting signal em, the fifth transistor T5 is turned on under the control of a low level of the fourth control signal cs4, the sixth transistor T6 is turned off under the control of the high level of the light emitting signal em, the seventh transistor T7 is turned off under the control of the high level of the light emitting signal em, the eighth transistor T8 is turned off under the control of a high level of the sixth control signal cs6, the ninth transistor T9 is turned off under the control of a high level of the seventh control signal cs7, the eleventh transistor T11 is turned off under the control of a high level of the eighth control signal cs8, and the twelfth transistor T12 is turned off under the control of the high level of the eighth control signal cs8. The turned-on fifth transistor T5 provides the data voltage signal of the data signal terminal DA to the first node N1, and the first capacitor C1 couples the data voltage signal of the first node N1 to the gate of the drive transistor T0, so that the voltage Vg of the gate of the drive transistor T0 is (Vref1+Vth+Vda-Vref2). The second capacitor C2 stabilizes the voltage at the first node N1.

In the light emitting stage F4: the first transistor T1 is turned off under the control of a high level of the first control signal cs1, the second transistor T2 is turned off under the control of a high level of the second control signal cs2, the third transistor T3 is turned off under the control of a high level of the second control signal cs2, the fourth transistor T4 is turned on under the control of a low level of the light emitting signal em, the fifth transistor T5 is turned off under the control a high level of the fourth control signal cs4, the sixth transistor T6 is turned on under the control of the low level of the light emitting signal em, the seventh transistor T7 is turned on under the control of the low level of the light emitting signal em, the eighth transistor T8 is turned off under the control of a high level of the sixth control signal cs6, the ninth transistor T9 is turned off under the control of a high level of the seventh control signal cs7, the eleventh transistor T11 is turned off under the control of a high level of the eighth control signal cs8, and the twelfth transistor T12 is turned off under the control of the high level of the eighth control signal cs8. The turned-on fourth transistor T4 provides the first initialization signal of the first initialization signal terminal VINIT1 to the second node N2, so that the voltage VN2 at the second node N2 is Vinit1. The turned-on sixth transistor T6 provides the first power supply voltage Vdd of the first power supply terminal VDD to the first electrode of the drive transistor T0, so that the voltage Vs at the first electrode of the drive transistor T0 is Vdd. The turned-on seventh transistor T7 makes conduction between the second electrode of the drive transistor T0 and the light emitting device L to drive the light emitting device L to emit light. Then, the drive transistor T0 operates in a saturation region, and the drive current I generated therefrom can be expressed as

$$I = \frac{k}{2} * {( Vgs - Vth )}^{2} = \frac{k}{2} * {( Vref 1 + Vda - Vref 2 - Vdd )}^{2} .$$

wherein

$$k = {μ C}_{ox} \frac{W}{L} ,$$

μ represents a mobility of the drive transistor T0, Cox represents a capacitance per unit area of a gate insulating layer of the drive transistor T0, and W/L represents a channel width to length ratio of the drive transistor T0.

Based on the same disclosure idea, the present disclosure embodiments also provide a display apparatus including the above pixel circuit provided by the embodiments of the present disclosure. The display apparatus solves the problem in a similar principle as the aforementioned pixel circuit, so the implementation of the display apparatus can be seen in the implementation of the aforementioned pixel circuit, and the repetition is not repeated herein.

In specific implementation, in the embodiments of the present disclosure, the display apparatus may be: a cellular phone, a tablet computer, a television, a monitor, a laptop computer, a digital photo frame, a navigator, and any other product or component having a display function. Other essential components of the display apparatus should be understood by those of ordinary skill in the art, and are not described herein, nor should they be taken as limitations on the present disclosure.

Although preferred embodiments of the present disclosure have been described, additional changes and modifications may be made to these embodiments once the basic inventive concepts are known to a person skilled in the art. Therefore, the appended claims are intended to be construed to include the preferred embodiments as well as all changes and modifications that fall within the scope of the present disclosure.

Obviously, a person skilled in the art can make various modifications and variations to the embodiments of the present disclosure without departing from the spirit and scope of the embodiments of the present disclosure. Thus, if such modifications and variations of the embodiments of the present disclosure fall within the scope of the claims of the present disclosure and their technical equivalents, the present disclosure is intended to include such modifications and variations.

1. A pixel circuit comprising:
a light emitting device;
a drive transistor, coupled to the light emitting device, and configured, according to a data voltage signal, to generate a drive current to drive the light emitting device to emit light;
a first compensation circuit, coupled to the drive transistor, and configured, in response to a signal of a first control signal terminal, to provide a first reference signal of a first reference signal terminal to a first electrode of the drive transistor;
a second compensation circuit, coupled to the drive transistor, and configured, in response to a signal of a second control signal terminal and a signal of a third control signal terminal, to provide a threshold voltage of the drive transistor and the first reference signal input into the first electrode of the drive transistor to a gate of the drive transistor;
a data writing circuit, coupled to a first node, and configured, in response to a signal of a fourth control signal terminal, to provide the data voltage signal of a data signal terminal to the first node;
a coupling control circuit, coupled to the first node and the drive transistor, and configured to couple the data voltage signal of the first node to the gate of the drive transistor; and
a light emitting control circuit, coupled to the light emitting device and the drive transistor, and configured, in response to a signal of a light emitting control signal terminal, to make conduction between the first electrode of the drive transistor and a first power supply terminal and make conduction between a second electrode of the drive transistor and the light emitting device to drive the light emitting device to emit light.

2. The pixel circuit according to claim 1, wherein the first compensation circuit comprises: a first transistor; wherein
a gate of the first transistor is coupled to the first control signal terminal, a first electrode of the first transistor is coupled to the first electrode of the drive transistor, and a second electrode of the first transistor is coupled to the first reference signal terminal.

3. The pixel circuit according to claim 1, wherein the second compensation circuit comprises: a second transistor and a third transistor; wherein
a gate of the second transistor is coupled to the second control signal terminal, a first electrode of the second transistor is coupled to a second node, and a second electrode of the second transistor is coupled to the second electrode of the drive transistor; and
a gate of the third transistor is coupled to the third control signal terminal, a first electrode of the third transistor is coupled to the gate of the drive transistor, and a second electrode of the third transistor is coupled to the second node.

4. The pixel circuit according to claim 3, wherein the second compensation circuit further comprises: a fourth transistor; wherein
a gate of the fourth transistor is coupled to a fifth control signal terminal, a first electrode of the fourth transistor is coupled to the gate of the drive transistor or the second node, and a second electrode of the fourth transistor is coupled to a first initialization signal terminal.

5. The pixel circuit according to claim 4, wherein the fifth control signal terminal and the light emitting control signal terminal are the same one signal terminal.

6. The pixel circuit according to any one of claim 1, wherein the data writing circuit comprises: a fifth transistor; wherein
a gate of the fifth transistor is coupled to the fourth control signal terminal, a first electrode of the fifth transistor is coupled to the data signal terminal, and a second electrode of the fifth transistor is coupled to the first node.

7. The pixel circuit according to claim 1, wherein the coupling control circuit comprises: a first capacitor; wherein
a first electrode of the first capacitor is coupled to the first node, and a second electrode of the first capacitor is coupled to the gate of the drive transistor.

8. The pixel circuit according to claim 1, wherein the light emitting control circuit comprises: a sixth transistor and a seventh transistor; wherein
a gate of the sixth transistor is coupled to the light emitting control signal terminal, a first electrode of the sixth transistor is coupled to the first power supply terminal, and a second electrode of the sixth transistor is coupled to the first electrode of the drive transistor; and
a gate of the seventh transistor is coupled to the light emitting control signal terminal, a first electrode of the seventh transistor is coupled to the second electrode of the drive transistor, and a second electrode of the seventh transistor is coupled to the light emitting device.

9. The pixel circuit according to claim 1, further comprising: a first reset circuit, coupled to the light emitting device, and configured, in response to a signal of a sixth control signal terminal, to provide a signal of a second initialization signal terminal to the light emitting device.

10. The pixel circuit according to claim 9, wherein the first reset circuit comprises: an eighth transistor; wherein
a gate of the eighth transistor is coupled to the sixth control signal terminal, a first electrode of the eighth transistor is coupled to the light emitting device, and a second electrode of the eighth transistor is coupled to the second initialization signal terminal.

11. The pixel circuit according to claim 1, further comprising: a voltage regulator circuit, coupled to the first node, and configured to stabilize a voltage at the first node.

12. The pixel circuit according to claim 11, wherein the voltage regulator circuit comprises: a second capacitor; wherein
a first electrode of the second capacitor is coupled to the first power supply terminal, and a second electrode of the second capacitor is coupled to the first node.

13. The pixel circuit according to claim 1, further comprising: a second reset circuit, coupled to the second electrode of the drive transistor, and configured, in response to a signal of a seventh control signal terminal, to provide a signal of a third initialization signal terminal to the second electrode of the drive transistor.

14. The pixel circuit according to claim 13, wherein the second reset circuit comprises: a ninth transistor; wherein
a gate of the ninth transistor is coupled to the seventh control signal terminal, a first electrode of the ninth transistor is coupled to the second electrode of the drive transistor, and a second electrode of the ninth transistor is coupled to the third initialization signal terminal.

15. The pixel circuit according to claim 1, further comprising: a third reset circuit, coupled to the first node, and configured, in response to a signal of an eighth control signal terminal, to provide a signal of a second reference signal terminal to the first node.

16. The pixel circuit according to claim 15, wherein the third reset circuit comprises: a tenth transistor; wherein
a gate of the tenth transistor is coupled to the eighth control signal terminal, a first electrode of the tenth transistor is coupled to the first node, and a second electrode of the tenth transistor is coupled to the second reference signal terminal.

17. The pixel circuit according to claim 15, wherein the third reset circuit comprises:
an eleventh transistor and a twelfth transistor; wherein
a gate of the eleventh transistor is coupled to the eighth control signal terminal, a first electrode of the eleventh transistor is coupled to the first node, and a second electrode of the eleventh transistor is coupled to a third node; and
a gate of the twelfth transistor is coupled to the eighth control signal terminal, a first electrode of the twelfth transistor is coupled to the third node, and a second electrode of the eleventh transistor is coupled to the second reference signal terminal.

18. The pixel circuit according to claim 17, wherein the third reset circuit further comprises: a thirteenth transistor; wherein
a gate of the thirteenth transistor is coupled to a ninth control signal terminal, a first electrode of the thirteenth transistor is coupled to the third node, and a second electrode of the thirteenth transistor is coupled to a third reference signal terminal.

19. A display apparatus, comprising a pixel circuit, wherein the pixel circuit comprises: a light emitting device;
a drive transistor, coupled to the light emitting device, and configured, according to a data voltage signal, to generate a drive current to drive the light emitting device to emit light;
a first compensation circuit, coupled to the drive transistor, and configured, in response to a signal of a first control signal terminal, to provide a first reference signal of a first reference signal terminal to a first electrode of the drive transistor;
a second compensation circuit, coupled to the drive transistor, and configured, in response to a signal of a second control signal terminal and a signal of a third control signal terminal, to provide a threshold voltage of the drive transistor and the first reference signal input into the first electrode of the drive transistor to a gate of the drive transistor;
a data writing circuit, coupled to a first node, and configured, in response to a signal of a fourth control signal terminal, to provide the data voltage signal of a data signal terminal to the first node;
a coupling control circuit, coupled to the first node and the drive transistor, and configured to couple the data voltage signal of the first node to the gate of the drive transistor; and
a light emitting control circuit, coupled to the light emitting device and the drive transistor, and configured, in response to a signal of a light emitting control signal terminal, to make conduction between the first electrode of the drive transistor and a first power supply terminal and make conduction between a second electrode of the drive transistor and the light emitting device to drive the light emitting device to emit light.

20. A driving method of the pixel circuit according to claim 1, comprising:
in a reset stage: providing, by the first compensation circuit, the first reference signal of the first reference signal terminal to the first electrode of the drive transistor in response to the signal of the first control signal terminal;
in a threshold compensation stage: providing, by the first compensation circuit, the first reference signal of the first reference signal terminal to the first electrode of the drive transistor in response to the signal of the first control signal terminal; and providing, by the second compensation circuit, the threshold voltage of the drive transistor and the first reference signal input into the first electrode of the drive transistor to the gate of the drive transistor in response to the signal of the second control signal terminal and the signal of the third control signal terminal;
in a data writing stage: providing, by the data writing circuit, the data voltage signal of the data signal terminal to the first node in response to the signal of the fourth control signal terminal; and coupling, by the coupling control circuit, the data voltage signal of the first node to the gate of the drive transistor; and
in a light emitting stage: making, by the light emitting control circuit, conduction between the first electrode of the drive transistor and the first power supply terminal, and conduction between the second electrode of the drive transistor and the light emitting device to drive the light emitting device to emit light in response to the signal of the light emitting control signal terminal.
